(19) United States
(12) Patent Application Publication
(10) Pub. No.: US 2021/0143457 A1
(43) Pub. Date: May 13, 2021

(54) APPARATUS AND METHOD FOR DIAGNOSING FAILURE IN FUEL CELL SYSTEM

(71) Applicants: HYUNDAI MOTOR COMPANY, Seoul (KR); KIA MOTORS CORPORATION, Seoul (KR)

(72) Inventors: Seong Cheol Jeong, Suwon-si (KR); Hyo Jin Park, Seongnam-si (KR); Soon Gil Kweon, Hwaseong-si (KR); Jong Gyun Kim, Yongin-si (KR)

(21) Appl. No.: 16/912,155

(22) Filed: Jun. 25, 2020

(30) Foreign Application Priority Data
Nov. 12, 2019 (KR) 10-2019-0144607

(51) Int. Cl. H01M 8/04664; H01M 8/04225; H01M 8/04302

(52) U.S. Cl. CPC H01M 8/04664; H01M 8/04302; H01M 8/04225

(57) ABSTRACT

The present disclosure relates to an apparatus and method for diagnosing a failure in a fuel cell system. To prevent degradation of a fuel cell stack due to abnormal supply of hydrogen, the apparatus includes a first pressure sensor that measures pressure of hydrogen supplied into the fuel cell stack, a second pressure sensor that measures the pressure of the hydrogen supplied into the fuel cell stack, and a controller that first diagnoses a supply state of the hydrogen based on a first pressure value measured by the first pressure sensor and a second pressure value measured by the second pressure sensor, and further diagnoses the supply state of the hydrogen based on an absolute value of a difference between the first pressure value and the second pressure value.

### CROSS REFERENCE TO RELATED APPLICATIONS

This application claims the benefit of priority to Korean Patent Application No. 10-2019-0144607, filed in the Korean Intellectual Property Office on Nov. 12, 2019, the entire contents of which are incorporated herein by reference.

### TECHNICAL FIELD

The present disclosure relates to a technology for diagnosing a failure in a fuel cell system mounted in a fuel cell electric vehicle.

### BACKGROUND

A fuel cell is a type of power generator that converts chemical energy of fuel into electrical energy through an electrochemical reaction within a fuel cell stack, instead of converting the chemical energy into heat through combustion. The fuel cell may not only provide power for industries, households, and vehicles, but may also be applied to power supply for compact electric/electronic products, especially, portable devices.

Currently, a Proton Exchange Membrane Fuel Cell (PEMFC), also known as a polymer electrolyte membrane fuel cell, having the highest power density among fuel cells is extensively being studied as a power source for driving a vehicle. The PEMFC has quick startup time and quick power conversion response time due to low operating temperature.

The PEMFC includes a Membrane Electrode Assembly (MEA) having catalyst electrode layers in which an electrochemical reaction occurs and that are attached to opposite sides of a solid polymer electrolyte membrane through which hydrogen ions move, a Gas Diffusion Layer (GDL) that serves to uniformly distribute reactant gases and deliver electrical energy generated, a gasket and a fastening member that prevent leakage of the reactant gases and cooling water and maintain appropriate fastening pressure, and a bipolar plate that allows the reactant gases and the cooling water to move therethrough.

When a fuel cell stack is assembled by using the configuration of the unit cell, a combination of the MEA and the GDL, which are main components, is located in the innermost position of the cell. The MEA includes the catalyst electrode layers, that is, an anode and a cathode that are attached to the opposite surfaces of the polymer electrolyte membrane, and that have a catalyst coated thereon so as to allow hydrogen and oxygen to react with each other. The GDL, the gasket, and the like are stacked on the outer portion where the anode and the cathode are located.

The bipolar plate having flow fields formed therein is located outward of the GDL, the flow fields supplying the reactant gases (hydrogen as a fuel and oxygen or air as an oxidizing agent) and allowing the cooling water to pass therethrough.

After a plurality of unit cells having the above-described configuration are stacked, current collectors, insulating plates, and end plates for supporting the stacked cells are coupled to the outermost portion of the fuel cell stack. The unit cells are repeatedly stacked and assembled between the end plates to form the fuel cell stack.

In order to obtain an electrical potential required for a vehicle, it is necessary to stack unit cells corresponding to the required electrical potential, and the stacked unit cells are called a stack. For example, an electrical potential generated from a single unit cell is about 1.3V, and in order to generate power required for driving the vehicle, the plurality of cells may be stacked in series.

Meanwhile, the pressure of hydrogen supplied into a fuel cell stack is one of very important control factors that determine the performance of a fuel cell system.

For example, when high-pressure hydrogen is supplied into the fuel cell stack, poor fuel economy may be caused by a phenomenon in which the hydrogen crosses over to an oxygen electrode. In contrast, when low-pressure hydrogen is supplied into the fuel cell stack, output power required for a vehicle may not be obtained, and degradation of the fuel cell stack may be accelerated due to damage to a catalyst. For reference, the hydrogen that crosses over to the oxygen electrode is released by air without any reaction.

A conventional technology for diagnosing a failure in a fuel cell system does not verify pressure values measured by a plurality of hydrogen pressure sensors and diagnoses a failure in the fuel cell system by using a deviation of the pressure values. Therefore, the conventional technology may misdiagnose the fuel cell system as having a failure even when the fuel cell system does not have the failure.

The information disclosed in the Background section is only for enhancement of understanding of the background of the present disclosure and may include information that is not the prior art already known to a person skilled in the art.

### SUMMARY

The present disclosure has been made to solve the above-mentioned problems occurring in the prior art while advantages achieved by the prior art are maintained intact.

An aspect of the present disclosure provides an apparatus and method for diagnosing a failure in a fuel cell system, in which the apparatus and method diagnoses whether hydrogen is smoothly supplied into a fuel cell stack by using a plurality of hydrogen pressure sensors and determines whether to shut down the fuel cell system, based on the diagnosis result, thereby preventing degradation of the fuel cell stack due to abnormal supply of hydrogen.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for diagnosing a failure in a fuel cell system includes a first pressure sensor that measures pressure of hydrogen supplied into a fuel cell stack, a second pressure sensor that measures the pressure of the hydrogen supplied into the fuel cell stack, and a controller that first diagnoses a supply state of the hydrogen based on a first pressure value measured by the first pressure sensor and a second pressure value measured by the second pressure sensor, and further diagnoses the supply state of the hydrogen based on an absolute value of a difference between the first pressure value and the second pressure value.

The controller may first diagnose the supply state of the hydrogen as being normal, when a minimum value of the first pressure value and the second pressure value is greater than or equal to a first threshold value.

The controller may further diagnose the supply state of the hydrogen as being abnormal, when the minimum value is smaller than the first threshold value and the absolute value exceeds a second threshold value.

The controller may further diagnose the supply state of the hydrogen as being abnormal, when a state in which the minimum value is smaller than the first threshold value and the absolute value exceeds a second threshold value continues for more than first threshold time.

The controller may start the fuel cell system, when a target pressure value minus a current pressure value is smaller than a third threshold value in a state in which a hydrogen supply system normally operates during the start of the fuel cell system. The current pressure value may be any one of the first pressure value, the second pressure value, a maximum value of the first pressure value and the second pressure value, and an average value of the first pressure value and the second pressure value.

The controller may start the fuel cell system, when a state in which there is no abnormality in a hydrogen supply system for second threshold time during the start of the fuel cell system and a target pressure value minus a current pressure value is smaller than a third threshold value continues for third threshold time. The current pressure value may be any one of the first pressure value, the second pressure value, a maximum value of the first pressure value and the second pressure value, and an average value of the first pressure value and the second pressure value.

The controller may diagnose the supply state of the hydrogen, based on a moving average value of the difference between the first pressure value and the second pressure value during operation of the fuel cell system. The controller may calculate the final target pressure value TP based on Equation 1, when diagnosing the supply state of the hydrogen as being abnormal.

According to another aspect of the present disclosure, a method for diagnosing a failure in a fuel cell system includes measuring, by a first pressure sensor, pressure of hydrogen supplied into a fuel cell stack, measuring, by a second pressure sensor, the pressure of the hydrogen supplied into the fuel cell stack, first diagnosing, by a controller, a supply state of the hydrogen based on a first pressure value measured by the first pressure sensor and a second pressure value measured by the second pressure sensor, and further diagnosing, by the controller, the supply state of the hydrogen based on an absolute value of a difference between the first pressure value and the second pressure value.

The first diagnosing of the supply state of the hydrogen may include first diagnosing the supply state of the hydrogen as being normal, when a minimum value of the first pressure value and the second pressure value is greater than or equal to a first threshold value.

The further diagnosing of the supply state of the hydrogen may include diagnosing the supply state of the hydrogen as being abnormal, when the minimum value is smaller than the first threshold value and the absolute value exceeds a second threshold value.

The further diagnosing of the supply state of the hydrogen may include diagnosing the supply state of the hydrogen as being abnormal, when a state in which the minimum value is smaller than the first threshold value and the absolute value exceeds a second threshold value continues for more than a first threshold time.

The method may further include starting the fuel cell system, when a target pressure value minus a current pressure value is smaller than a third threshold value in a state in which a hydrogen supply system normally operates during the start of the fuel cell system. The current pressure value may be any one of the first pressure value, the second pressure value, a maximum value of the first pressure value and the second pressure value, and an average value of the first pressure value and the second pressure value.

The method may further include starting the fuel cell system, when a state in which there is no abnormality in a hydrogen supply system for second threshold time during the start of the fuel cell system and a target pressure value minus a current pressure value is smaller than a third threshold value continues for third threshold time. The current pressure value may be any one of the first pressure value, the second pressure value, a maximum value of the first pressure value and the second pressure value, and an average value of the first pressure value and the second pressure value.

The method may further include diagnosing the supply state of the hydrogen, based on a moving average value of the difference between the first pressure value and the second pressure value during operation of the fuel cell system. At this time, the final target pressure value TP may be calculated based on Equation 1, when the supply state of the hydrogen is diagnosed as being abnormal.

### BRIEF DESCRIPTION OF THE FIGURES

The above and other objects, features and advantages of the present disclosure will be more apparent from the following detailed description taken in conjunction with the accompanying drawings:

FIG. 1 is a view illustrating the structure of a fuel cell system to which one embodiment of the present disclosure is applied;

FIG. 2 is a view illustrating a configuration of an apparatus for diagnosing a failure in the fuel cell system according to one embodiment of the present disclosure;

FIG. 3 is a first flowchart illustrating a method for diagnosing a failure in the fuel cell system according to one embodiment of the present disclosure;

FIG. 4 is a second flowchart illustrating a method for diagnosing a failure in the fuel cell system according to one embodiment of the present disclosure;

FIG. 5 is a third flowchart illustrating a method for diagnosing a failure in the fuel cell system according to one embodiment of the present disclosure; and

FIG. 6 is a block diagram illustrating a computing system for executing the failure diagnosis method for the fuel cell system according to one embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

FIG. 1 is a view illustrating the structure of a fuel cell system to which one embodiment of the present disclosure is applied, and is focused on a hydrogen supply system consistent with the spirit of one embodiment of the present disclosure.

As illustrated in FIG. 1, the fuel cell system to which one embodiment of the present disclosure is applied may include an FBV 100, an FSV 110, an FEJ 120, a first pressure sensor 130, a second pressure sensor 131, a Fuel Cell Stack (FCS) 140, an FPV 150, an FWT 160, an FL20 170, and an FDV 180.

The Fuel Block Valve (FBV) 100 serves to block hydrogen supplied into the FCS 140.

The Fuel Supply Valve (FSV) 110 serves to adjust the pressure of the hydrogen supplied into the FCS 140.

The Fuel Ejector (FEJ) 120 serves to re-circulate the hydrogen at fuel electrodes.

The first pressure sensor 130 serves to measure the pressure of the hydrogen that is supplied into the FCS 140.

The second pressure sensor 131 also serves to measure the pressure of the hydrogen that is supplied into the FCS 140.

The FCS 140 produces electricity using a chemical reaction of hydrogen and oxygen.

The FPV 150, which is a fuel-line purge valve, serves to discharge fuel-electrode condensed water and impurities in the FCS 140.

The FWT 160, which is a fuel-line water trap, serves to store water.

The FL20 170, which is a fuel-line level sensor, serves to measure the level of the water stored in the FWT 160.

The FDV 180, which is a fuel-line drain valve, serves to drain the water stored in the FWT 160.

FIG. 2 is a view illustrating a configuration of an apparatus for diagnosing a failure in the fuel cell system according to one embodiment of the present disclosure.

As illustrated in FIG. 2, the failure diagnosis apparatus 10 for the fuel cell system according to one embodiment of the present disclosure may include storage 11, a display 12, and a controller 13. The components may be combined together to form one entity, or some of the components may be omitted, depending on a way of carrying out the failure diagnosis apparatus 10 for the fuel cell system according to one embodiment of the present disclosure.

Descriptions of the components will be given below. First, the storage 11 may store various types of logic, algorithms, and programs required in the process of diagnosing whether hydrogen is smoothly supplied into the FCS 140, by using the plurality of pressure sensors 130 and 131, and determining whether to shut down the fuel cell system, based on the diagnosis result. Here, the shutdown of the fuel cell system represents a state in which the supply of hydrogen into the FCS 140 is blocked so that operation of the FCS 140 is stopped.

The storage 11 may store a first threshold value P1 for a pressure value measured by the first pressure sensor 130 or a pressure value measured by the second pressure sensor 131. Here, the first threshold value P1 is preferably set to a pressure value (e.g., 50 kPa) that is difficult to physically measure.

The storage 11 may store a second threshold value P2 for the difference between the pressure value measured by the first pressure sensor 130 and the pressure value measured by the second pressure sensor 131. Here, the second threshold value P2 is preferably set to a pressure value (e.g., 30 kPa) at which excess hydrogen is likely to be supplied into the FCS 140 due to the difference between the pressure value measured by the first pressure sensor 130 and the pressure value measured by the second pressure sensor 131.

The storage 11 may store first threshold time T1 (e.g., 200 ms) for time satisfying a specific condition. Here, when the first threshold time T1 is too long, supply of excess hydrogen into the FCS 140 cannot be prevented, and when the first threshold time T1 is too short, misdiagnosis may be caused.

Furthermore, the storage 11 may store second threshold time T2 for time during which hydrogen continues to be smoothly supplied during start of the fuel cell system. Here, the second threshold time T2 may be set to, for example, 2 seconds.

The storage 11 may store a target pressure value of hydrogen during start of the fuel cell system. Here, the target pressure value of hydrogen may be set to, for example, 130 kPa.

The storage 11 may store a third threshold value P3 (e.g., 10 kPa) for the difference between the target pressure value of hydrogen and the current pressure value (the pressure value measured by the first pressure sensor 130 or the second pressure sensor 131). Here, when the third threshold value P3 is set to too small of a value, the number of failures in start may increase, and when the third threshold value P3 is set to too large a value, start of the fuel cell system may be completed in a state in which the pressure of hydrogen supplied into the FCS 140 is low. This generates backward voltage to accelerate degradation of the FCS 140.

The storage 11 may store third threshold time T3 for time during which the difference between the target pressure value of hydrogen and the current pressure value (the pressure value measured by the first pressure sensor 130 or the second pressure sensor 131) exceeds the third threshold value P3. Here, the third threshold time T3 may be set to, for example, 500 ms.

Furthermore, the storage 11 may store a fourth threshold value P4 (e.g., 100 kPa) for the pressure value measured by the first pressure sensor 130 and the pressure value measured by the second pressure sensor 131 while the fuel cell system is in operation. Here, the fourth threshold value P4 is a value that is used to determine whether to perform failure diagnosis while the fuel cell system is in operation.

The storage 11 may store a fifth threshold value P5 (e.g., 4 kPa) for a moving average value of the difference between the pressure value measured by the first pressure sensor 130 and the pressure value measured by the second pressure sensor 131. Here, when the fifth threshold value P5 is set to be too large, operation of the fuel cell system may be continued in a hydrogen shortage state, and when the fifth threshold value P5 is set to be too small, excess hydrogen may be supplied to lower the fuel ratio.

The storage 11 may include at least one type of storage medium among memories of a flash memory type, a hard disk type, a micro type, and a card type (e.g., a Secure Digital (SD) card or an eXtream Digital (XD) card) and memories of a Random Access Memory (RAM) type, a Static RAM (SRAM) type, a Read-Only Memory (ROM) type, a Programmable ROM (PROM) type, an Electrically Erasable PROM (EEPROM) type, a Magnetic RAM (MRAM) type, a magnetic disk type, and an optical disk type.

The display 12 may be implemented with a cluster, a Head-Up Display (HUD), or an Audio Video Navigation (AVN) system and may provide, to a user, an outcome of diagnosing a failure in the fuel cell system.

The controller 13 performs overall control to enable the components to normally perform functions thereof. The controller 13 may be implemented in a hardware or software form, or may be implemented in a form in which hardware and software are combined. The controller 13 may preferably be implemented with, but is not limited to, a microprocessor.

The controller 13 may perform various controls required in the process of diagnosing whether hydrogen is smoothly supplied into the FCS 140, by using the plurality of pressure sensors 130 and 131, and determining whether to shut down the fuel cell system, based on the diagnosis result.

The controller 13 may perform a timer function.

Hereinafter, an operation of the controller 13 will be described in detail with reference to FIGS. 3 to 5.

FIG. 3 is a first flowchart illustrating a method for diagnosing a failure in the fuel cell system according to one embodiment of the present disclosure.

First, when hydrogen is supplied into the FCS 140, the controller 13 detects the minimum value Pm of a first pressure value measured by the first pressure sensor 130 and a second pressure value measured by the second pressure sensor 131 at 301 and 302. At this time, the first pressure sensor 130 and the second pressure sensor 131 may periodically measure the pressure of the hydrogen supplied into the FCS 140.

Next, the controller 13 determines whether the detected minimum value Pm is smaller than the first threshold value P1 at 303.

When the determination result 303 shows that the detected minimum value Pm is not smaller than the first threshold value P1, the controller 13 determines both the state of the first pressure sensor 130 and the state of the second pressure sensor 131 to be normal, and proceeds to “302”.

When the determination result 303 shows that the detected minimum value Pm is smaller than the first threshold value P1, the controller 13 calculates the absolute value Pa of the difference between the first pressure value and the second pressure value at 304.

Next, the controller 13 determines whether the calculated absolute value Pa exceeds the second threshold value P2 at 305.

When the determination result 305 shows that the calculated absolute value Pa does not exceed the second threshold value P2, the controller 13 determines both the state of the first pressure sensor 130 and the state of the second pressure sensor 131 to be normal and proceeds to “302”.

When the determination result 305 shows that the calculated absolute value Pa exceeds the second threshold value P2, the controller 13 determines that the fuel cell system has a failure (the supply of hydrogen is abnormal), and stops the supply of hydrogen at 306. When the state in which the detected minimum value Pm is smaller than the first threshold value P1 and the calculated absolute value Pa exceeds the second threshold value P2 continues for more than the first threshold time T1, the controller 13 may determine that the fuel cell system has a failure, and may stop the supply of hydrogen.

FIG. 4 is a second flowchart illustrating a method for diagnosing a failure in the fuel cell system according to one embodiment of the present disclosure.

First, when starting the fuel cell system at 401, the controller 13 determines whether the hydrogen supply system in the fuel cell system illustrated in FIG. 1 normally operates at 402. When starting the fuel cell system, the controller 13 may determine, through a controller of the hydrogen supply system, whether hydrogen is normally supplied into the FCS 140.

When the determination result 402 shows that there is an abnormality in the hydrogen supply system, the controller 13 stops the start of the fuel cell system at 403.

When the determination result 402 shows that there is no abnormality in the hydrogen supply system, the controller 13 determines whether the difference between the target pressure value (constant value) at the time of start and the current pressure value is smaller than the third threshold value P3 at 404. Here, the current pressure value, which is a sensor pressure value, may be any one of a first pressure value measured by the first pressure sensor 130, a second pressure value measured by the second pressure sensor 131, the maximum value of the first pressure value and the second pressure value, and the average value of the first pressure value and the second pressure value.

When the determination result 404 shows that the difference between the target pressure value (constant value) at the time of start and the current pressure value is not smaller than the third threshold value P3, the controller 13 stops the start of the fuel cell system at 403.

When the determination result 404 shows that the difference between the target pressure value (constant value) at the time of start and the current pressure value is smaller than the third threshold value P3, the controller 13 completes the start of the fuel cell system at 405. When the state in which there is no abnormality in the hydrogen supply system for the second threshold time and the difference between the target pressure value (constant value) at the time of start and the current pressure value is smaller than the third threshold value P3 continues for the third threshold time T3, the controller 13 may complete the start of the fuel cell system.

The diagnosis process in the second flowchart may be additionally performed while the diagnosis process in the first flowchart is performed.

FIG. 5 is a third flowchart illustrating a method for diagnosing a failure in the fuel cell system according to one embodiment of the present disclosure.

First, the controller 13 calculates a target pressure value TP1 corresponding to output power requirements during operation of the fuel cell system at 501.

Next, the controller 13 determines whether the current pressure value exceeds the fourth threshold value P4 at 502. Here, the current pressure value, which is a sensor pressure value, may be any one of a first pressure value measured by the first pressure sensor 130, a second pressure value measured by the second pressure sensor 131, the maximum value of the first pressure value and the second pressure value, and the average value of the first pressure value and the second pressure value.

When the determination result 502 shows that the current pressure value does not exceed the fourth threshold value P4, the controller 13 diagnoses that the fuel cell system does not have a failure, and sets the calculated target pressure value TP1 to the final target pressure value TP at 503.

When the determination result 502 shows that the current pressure value exceeds the fourth threshold value P4, the controller 13 calculates a moving average value E1 of the difference between the first pressure value measured by the first pressure sensor 130 and the second pressure value measured by the second pressure sensor 131 at 504.

Then, the controller 13 determines whether the calculated moving average value E1 exceeds the fifth threshold value P5 at 505.

When the determination result 505 shows that the calculated moving average value E1 does not exceed the fifth threshold value P5, the controller 13 diagnoses that the fuel cell system does not have a failure, and sets the calculated target pressure value TP1 to the final target pressure value TP at 503.

When the determination result shows that the calculated moving average value E1 exceeds the fifth threshold value P5, the controller 13 calculates the final target pressure value TP, based on Equation 1 below at 506.

TP=TP1+(A×E1) Equation 1:

Here, TP1 denotes the target pressure value corresponding to the output power requirements, and E1 denotes the moving average value of the difference between the first pressure value measured by the first pressure sensor 130 and the second pressure value measured by the second pressure sensor 131. At this time, A is a constant value (a weighting value) that satisfies the relation 0<A<1 and may be, for example, 0.5.

Meanwhile, in a state in which operation of the fuel cell system is stopped, the controller 13 may correct measurement errors of the first pressure sensor 130 and the second pressure sensor 131 when there is a history in which the moving average value E1 has exceeded the fifth threshold value P5.

The diagnosis process in the third flowchart may be additionally performed while the diagnosis process in the first flowchart is performed, or may be performed after the diagnosis process in the second flowchart is performed.

FIG. 6 is a block diagram illustrating a computing system for executing the failure diagnosis method for the fuel cell system according to one embodiment of the present disclosure.

Referring to FIG. 6, the failure diagnosis method for the fuel cell system according to one embodiment of the present disclosure may be implemented through the computing system 1000. The computing system 1000 may include at least one processor 1100, a memory 1300, a user interface input device 1400, a user interface output device 1500, storage 1600, and a network interface 1700, which are connected with each other via a bus 1200.

The processor 1100 may be a Central Processing Unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, or a CD-ROM. The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an Application Specific Integrated Circuit (ASIC). The ASIC may reside within a user terminal. In another case, the processor 1100 and the storage medium may reside in the user terminal as separate components.

According to the embodiments of the present disclosure, the apparatus and method for diagnosing a failure in the fuel cell system diagnoses whether hydrogen is smoothly supplied into the fuel cell stack, by using the plurality of hydrogen pressure sensors and determines whether to shut down the fuel cell system, based on the diagnosis result, thereby preventing degradation of the fuel cell stack due to abnormal supply of hydrogen.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

1. An apparatus for diagnosing a failure in a fuel cell system, the apparatus comprising:
a first pressure sensor configured to measure pressure of hydrogen supplied into a fuel cell stack;
a second pressure sensor configured to measure the pressure of the hydrogen supplied into the fuel cell stack; and
a controller configured to first diagnose a supply state of the hydrogen based on a first pressure value measured by the first pressure sensor and a second pressure value measured by the second pressure sensor, and to further diagnose the supply state of the hydrogen based on an absolute value of a difference between the first pressure value and the second pressure value.

2. The apparatus of claim 1, wherein the controller first diagnoses the supply state of the hydrogen as being normal when a minimum value of the first pressure value and the second pressure value is greater than or equal to a first threshold value.

3. The apparatus of claim 2, wherein the controller further diagnoses the supply state of the hydrogen as being abnormal when the minimum value is smaller than the first threshold value and the absolute value exceeds a second threshold value.

4. The apparatus of claim 2, wherein the controller further diagnoses the supply state of the hydrogen as being abnormal when a state in which the minimum value is smaller than the first threshold value, and the absolute value exceeds a second threshold value continues for more than a first threshold time.

5. The apparatus of claim 1, wherein the controller starts the fuel cell system when a target pressure value minus a current pressure value is smaller than a third threshold value, in a state in which a hydrogen supply system normally operates during the start of the fuel cell system.

6. The apparatus of claim 5, wherein the current pressure value is any one of the first pressure value, the second pressure value, a maximum value of the first pressure value and the second pressure value, and an average value of the first pressure value and the second pressure value.

7. The apparatus of claim 1, wherein the controller starts the fuel cell system when in a state in which there is no abnormality in a hydrogen supply system for a second threshold time during the start of the fuel cell system, and when a target pressure value minus a current pressure value is smaller than a third threshold value continues for a third threshold time.

8. The apparatus of claim 7, wherein the current pressure value is any one of the first pressure value, the second pressure value, a maximum value of the first pressure value and the second pressure value, and an average value of the first pressure value and the second pressure value.

9. The apparatus of claim 1, wherein the controller diagnoses the supply state of the hydrogen based on a moving average value of the difference between the first pressure value and the second pressure value during operation of the fuel cell system.

10. The apparatus of claim 9, wherein the controller calculates the final target pressure value TP based on TP=TP1+(A×E1), when diagnosing the supply state of the hydrogen as being abnormal,
where TP1 denotes a target pressure value corresponding to output power requirements, E1 denotes the moving average value, and A denotes a weighting value.

11. A method for diagnosing a failure in a fuel cell system, the method comprising:
measuring, by a first pressure sensor, pressure of hydrogen supplied into a fuel cell stack;
measuring, by a second pressure sensor, the pressure of the hydrogen supplied into the fuel cell stack;
first diagnosing, by a controller, a supply state of the hydrogen based on a first pressure value measured by the first pressure sensor and a second pressure value measured by the second pressure sensor; and
further diagnosing, by the controller, the supply state of the hydrogen, based on an absolute value of a difference between the first pressure value and the second pressure value.

12. The method of claim 11, wherein the first diagnosing of the supply state of the hydrogen includes:
first diagnosing the supply state of the hydrogen as being normal when a minimum value of the first pressure value and the second pressure value is greater than or equal to a first threshold value.

13. The method of claim 12, wherein the further diagnosing of the supply state of the hydrogen includes:
diagnosing the supply state of the hydrogen as being abnormal when the minimum value is smaller than the first threshold value and the absolute value exceeds a second threshold value.

14. The method of claim 12, wherein the further diagnosing of the supply state of the hydrogen includes:
diagnosing the supply state of the hydrogen as being abnormal when a state in which the minimum value is smaller than the first threshold value, and the absolute value exceeds a second threshold value continues for more than a first threshold time.

15. The method of claim 11, further comprising:
starting the fuel cell system when a target pressure value minus a current pressure value is smaller than a third threshold value in a state in which a hydrogen supply system normally operates during the start of the fuel cell system.

16. The method of claim 15, wherein the current pressure value is any one of the first pressure value, the second pressure value, a maximum value of the first pressure value and the second pressure value, and an average value of the first pressure value and the second pressure value.

17. The method of claim 11, further comprising:
starting the fuel cell system when in a state in which there is no abnormality in a hydrogen supply system for a second threshold time during the start of the fuel cell system, and a target pressure value minus a current pressure value is smaller than a third threshold value continues for a third threshold time.

18. The method of claim 17, wherein the current pressure value is any one of the first pressure value, the second pressure value, a maximum value of the first pressure value and the second pressure value, and an average value of the first pressure value and the second pressure value.

19. The method of claim 11, further comprising:
diagnosing the supply state of the hydrogen based on a moving average value of the difference between the first pressure value and the second pressure value during operation of the fuel cell system.

20. The method of claim 19, where the diagnosing of the supply state of the hydrogen based on the moving average value includes:
calculating the final target pressure value TP based on TP=TP1+(A×E1), when diagnosing the supply state of the hydrogen as being abnormal,
where, TP1 denotes a target pressure value corresponding to output power requirements, E1 denotes the moving average value, and A denotes a weighting value.
